(19) United States
(12) Patent Application Publication
(10) Pub. No.: US 2003/0134973 A1
(43) Pub. Date: Jul. 17, 2003

(54) Waterborne latexes for anti-corrosive and solvent-resistant coating compositions

(76) Inventors: Robert Gow-Sheng Chen, Kingsport, TN (US); David Logan Murray, Fall Branch, TN (US)

Correspondence Address: Michael K. Carrier, Eastman Chemical Company, P.O. Box 511, Kingsport, TN, 37662-5075, US

(21) Appl. No.: 10/186,147

(22) Filed: Jun. 27, 2002

Related U.S. Application Data
(60) Provisional application No. 60/348,131, filed on Jan. 15, 2002.

(51) Int. Cl. C08K 3/00

(52) U.S. Cl. 524/804

(57) ABSTRACT

The specification discloses a latex composition containing an acetoacetoxy-functional polymer which is the emulsion polymerization product of:

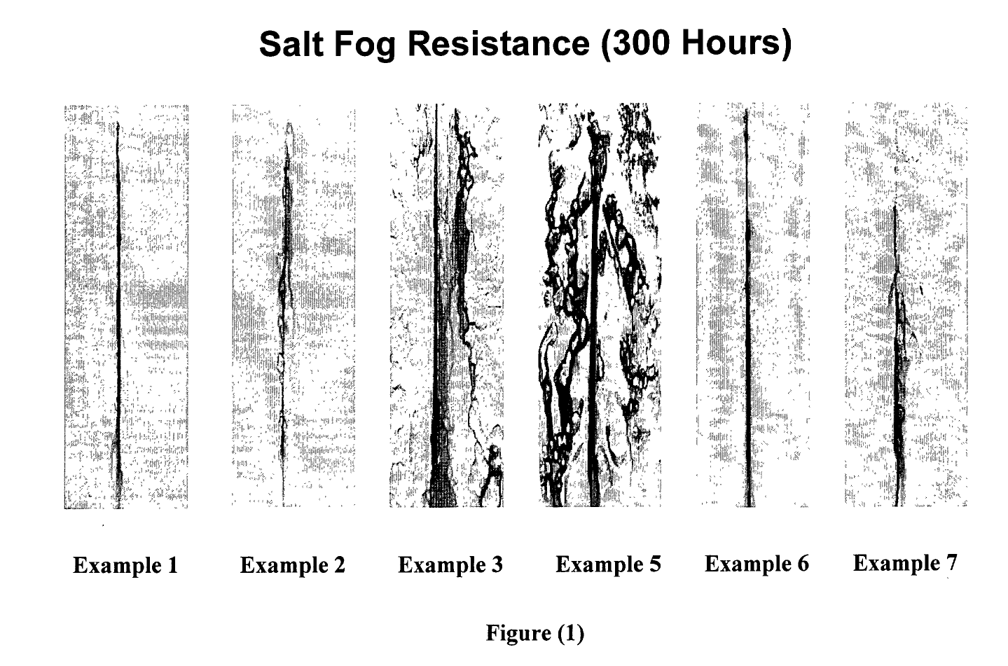

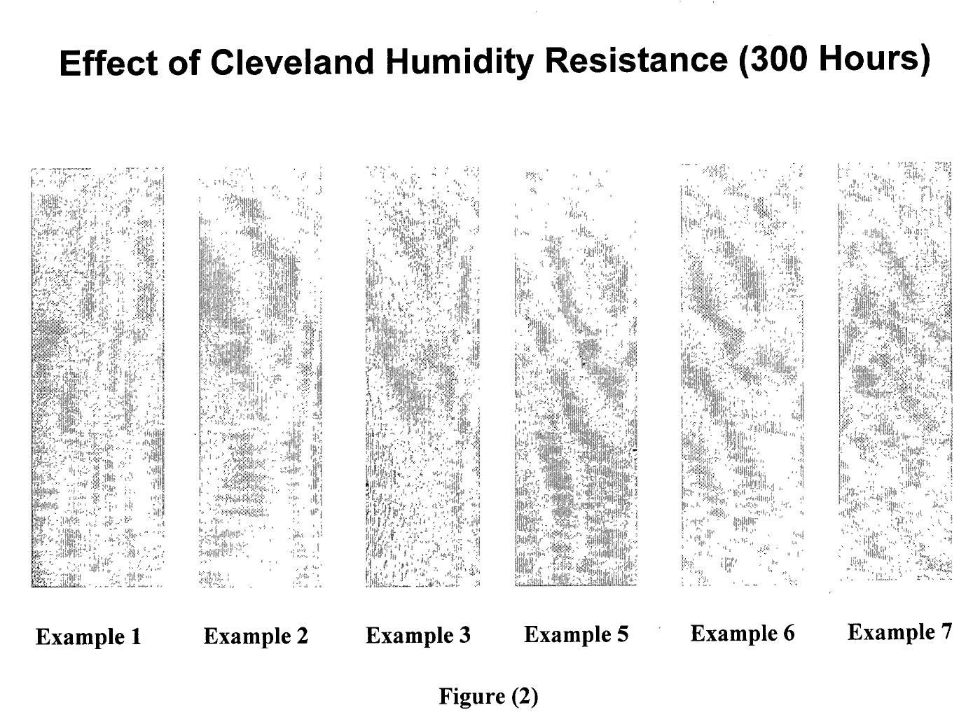

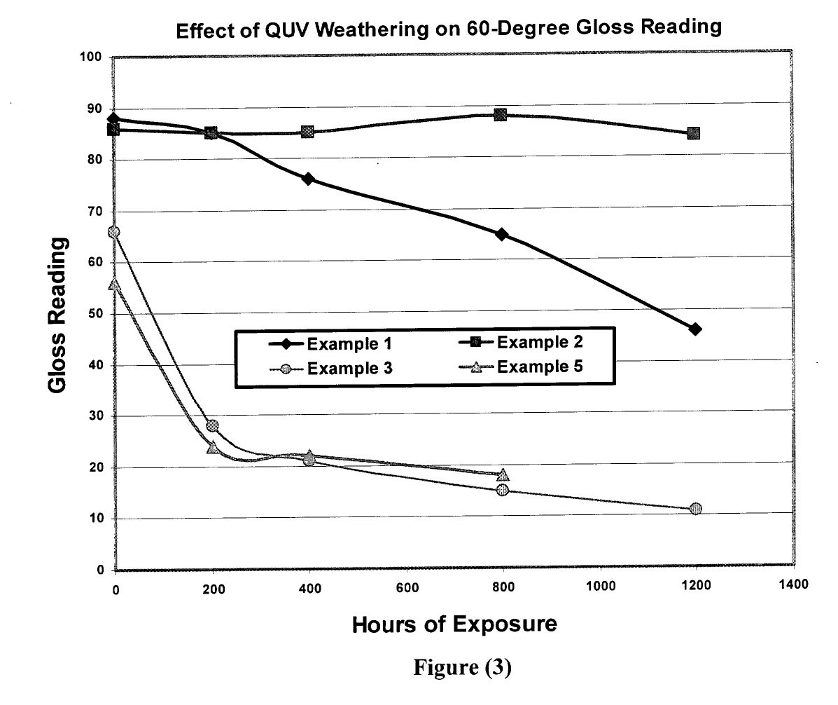

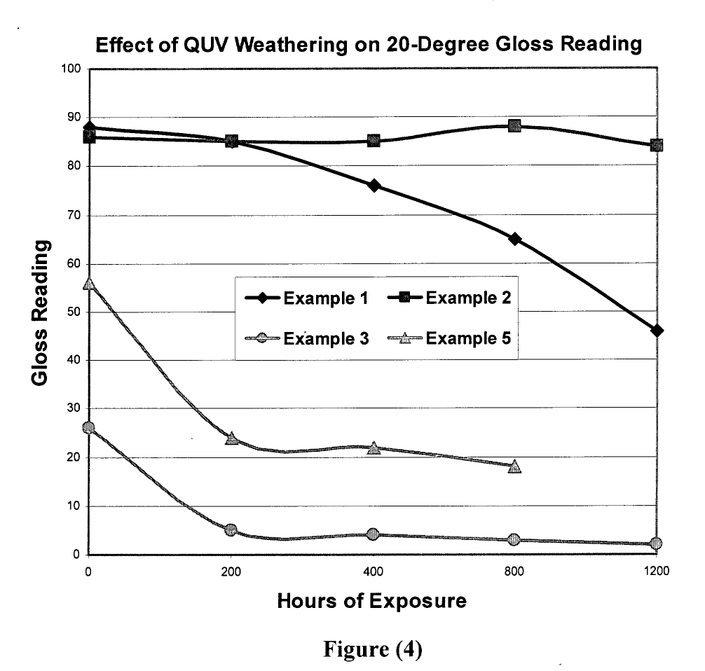

(i) about 0.5 to about 30 wt % of at least one acetoacetoxy-functional monomer;

(ii) about 0.3 to about 6 wt % of at least one carboxylic acid-functional vinyl monomer; and

(iii) about 60 to about 99.2 wt % of at least one non-acid, non-acetoacetoxy vinyl monomer. The acetoacetoxy functional polymer may also contain other monomers, such as one or more non-self polymerizing, surface-active vinyl monomers, or one or more adhesion-promoting monomers. The specification also discloses a latex composition containing the acetoacetoxy-functional polymer described above and a poly(alkylenimine), such as poly(ethylenimine). The latex compositions find utility in water-based coating compositions for metal surfaces. The latexes provide anti-corrosive and solvent-resistant properties to the coating compositions.

### CROSS REFERENCE TO RELATED APPLICATION

This application claims the benefit of U.S. Provisional Application Serial No. 60/348,131 filed Jan. 15, 2002.

### FIELD OF THE INVENTION

The invention relates to waterborne latexes for anti-corrosive and solvent-resistant coating compositions. More particularly, the invention relates to acetoacetoxy-functional polymer latexes and their use in anti-corrosive and solvent-resistant coating compositions.

### BACKGROUND OF THE INVENTION

The corrosion of metals is an electrochemical process that degrades a metal's surface. Corrosion of commercially useful metals such as steel results in major economic losses. In an effort to prevent corrosion, polymer-based coatings have been applied to metal surfaces.

The surface of clean steel exists not as iron, but rather, as hydrated iron oxides which are present as a monolayer. Adhesion of polymer coatings to this surface is promoted by the development of hydrogen bond interactions between the polymer and the oxide/hydroxide groups existing on the steel's surface. Functional groups that are capable of developing hydrogen bonds include amines (strong hydrogen acceptors), carboxylic acids (strong hydrogen donors), phosphate esters, hydroxyl groups, urethanes, ureido groups, and amides.

The process of corrosion begins when water and oxygen permeate through a protected metal's coating and displace some of the adsorbed groups of the coating from the metal's surface. Accordingly, adhesion, especially wet adhesion, is important in achieving effective corrosion protection. Adequate wet adhesion is achieved when the adsorbed layer of the coating will not be desorbed from the metal surface when water penetrates the polymer film and approaches the interface between the coating and the metal surface.

Permeability of water and oxygen through the polymer film is a function of both the glass transition temperature (T_{g}) of the polymer film and the temperature of the environment. If the environment temperature is higher than the T_{g} of the polymer film, water and oxygen can easily permeate the polymer film through the free-volume of the polymer. However, an emulsion polymer with a high T_{g} may prevent the polymer particles in the coating composition from coalescing and fusing together to form a continuous film.

Waterborne latexes having various functional groups have been used to impart desired properties to a particular coating composition. Examples of these latexes include emulsion polymers of vinyl acetate, styrene, butadiene, styrene-butadiene, vinyl acetate-vinyl chloride, acrylonitrile-butadiene, isoprene, vinylidene chloride-acrylonitrile, acrylic esters-methacrylic esters, copolymers of acrylic esters and methacrylic esters with other vinyl monomers, natural rubbers, and carboxylated synthetic rubbers. Other well-known waterborne paints include emulsions of epoxies, alkyds, phthalic alkyds, emulsified drying oils, and the like. However, these traditional polymers typically perform only marginally in anti-corrosive coatings formulations.

WO 01/19934 describes a method of inhibiting oxidation on a metal surface by application of a coating composition containing at least one surface-active containing macromonomer.

U.S. Pat. No. 5,973,029 describes core/shell latexes, prepared by emulsion polymerization, that are said to have improved resistance to corrosion. The use of the salt form of acrylamido-2-methylpropane sulfonic acid as a monomer is taught to be critical, as is the use of a diphenyl sulfonate surfactant.

U.S. Pat. No. 5,082,895 describes the use of large particle size latex compositions for corrosion resistant coatings. The latexes are prepared from a monomeric mixture of 2-ethylhexyl acrylate, styrene, methyl methacrylate, acrylonitrile, and acrylic or methacrylic acid.

U.S. Pat. No. 4,108,811 describes water-based latex compositions for coating corrodible metals prepared by first emulsifying, under alkaline conditions, a film-forming oxidative curable oil or alkyd-modified polyurethane, and then blending therewith acrylic or vinyl acetate copolymers or homopolymers.

U.S. Pat. Nos. 4,243,416 and 4,243,417 describe the combined use of a soluble complex of a polyvalent agent, a volatile complexing agent, and a corrosion inhibiting anion, to provide latex paints with corrosion resistance properties for application on iron or steel structures. The complex may be represented by the formula M(Z)ₓAn, where M is the metal cation, An is the corrosion inhibiting anion, Z is the complexing volatile component, and x is the number of moles of volatile complexing agent per mole of M. Examples include zinc ammonium carbonate and zinc ammonium molybdate.

U.S. Pat. No. 5,783,626 describes allyl-functional polymers having pendant enamine groups that are the reaction products of poly(ethylenimine) (PEI) with acetoacetoxy-functional latexes. The polymers of this invention have only limited application in metals coatings.

JP 2000026762 describes the preparation of an anti-corrosive emulsion composition from copolymerization of a hydroxyacrylate monomer, acetoacetoxyethyl methacrylate, and another ethylenically unsaturated monomer.

### SUMMARY OF THE INVENTION

The invention relates to a latex composition comprising an acetoacetoxy-functional polymer. The acetoacetoxy-functional polymer is the emulsion polymerization product of:

(i) about 0.5 to about 30 wt % of one or more acetoacetoxy-functional monomers;

(ii) about 0.3 to about 6 wt % of one or more acid-functional vinyl monomers; and

(iii) about 60 to about 99.2 wt % of one or more non-acid, non-acetoacetoxy vinyl monomers. The monomers used to produce the acetoacetoxy-functional polymer may also include one or more non-self polymerizing, surface-active vinyl monomers, and one or more adhesion-promoting monomers.

The invention also relates to a latex composition containing one or more acetoacetoxy-functional polymers, such as just described, and one or more poly(alkylenimines). A preferred poly(alkylenimine) is poly(ethylenimine).

The invention relates also to water-based coating compositions for use on metal surfaces. The water-based coating compositions contain a latex composition of the invention. The coating compositions possess anti-corrosive and solvent-resistant properties.

Another embodiment of the invention provides an anti-corrosive and solvent-resistant film composition comprising a polymeric (polyamino) enamine latex wherein the polymeric (polyamino) enamine latex is the reaction product of one or more acetoacetoxy-functional polymers and one or more poly(alkylenimines).

In another embodiment of the invention, the acetoacetoxy-functional polymer component of the enamine further comprises about 0.5 to about 5 wt % of one or more non-self polymerizing, surface-active vinyl monomers.

### BRIEF DESCRIPTION OF THE FIGURES

FIG. (1) depicts the results of panels coated with paints formulated with latexes of the invention and exposed to 300 hours of exposure to salt fog spray.

FIG. (2) depicts the results of Cleveland humidity tests with panels coated with paints formulated with latexes of the invention.

FIG. (3) depicts the results of QUV Weathering tests to demonstrate the effect of weathering on gloss at 60° of panels coated with paints formulated with latexes of the invention.

FIG. (4) depicts the results of QUV Weathering tests to demonstrate the effect of weathering on gloss at 20° of panels coated with paints formulated with latexes of the invention.

### DETAILED DESCRIPTION OF THE INVENTION

In the following, the singular forms “a,” “an,” and “the” include the plural, unless the context clearly dictates otherwise. Further, the words “optional” and “optionally” mean that the subsequently described event or circumstance may or may not occur.

The invention relates to a latex composition comprising an acetoacetoxy-functional polymer which is the emulsion polymerization product of:

(i) about 0.5 to about 30 wt % of an acetoacetoxy-functional monomer;

(ii) about 0.3 to about 6 wt % of an acid-functional vinyl monomer, preferably a carboxylic acid-functional vinyl monomer; and

(iii) about 60 to about 99.2 wt % of a non-acid, non-acetoacetoxy vinyl monomer.

In a preferred embodiment of the invention, the monomers polymerized to produce the acetoacetoxy-functional polymer further comprise (iv) about 0.5 to about 5 wt % of a non-self polymerizing, surface-active vinyl monomer. A latex composition of the invention may be used in a water-based, anti-corrosive coating composition for metal surfaces. A water-based anti-corrosive composition of the invention demonstrates excellent gloss and resistance to salt fog spray and high humidity conditions.

In the latex of the invention the acetoacetoxy-functional polymer has a particle size ranging from about 80 to about 300 nm. The T_{g} ranges from about 0° C. to about 80° C., or from about 15° C. to about 60° C.

Another embodiment of the invention combines a poly(alkylenimine) with the latex composition comprising the acetoacetoxy-functional polymer. This combination may also be used in water-based, anti-corrosive coating compositions. Blending the acetoacetoxy-functional polymer with a poly(alkylenimine) has the additional advantage of imparting solvent resistance to the water-based coating composition. An anti-corrosive and solvent-resistant coating composition containing a blend of an acetoacetoxy-functional polymer latex and a poly(alkylenimine) according to the invention demonstrates excellent hardness, gloss, gloss retention, solvent and chemical resistance, and weathering, without compromising anti-corrosion performance. Application of the coating composition to a substrate prompts crosslinking within the film composition through dehydration and resulting enamine formation through reaction of the acetoacetoxy moieties on the acetoacetoxy-functional polymer with the poly(alkylenimine). Such a coating composition may be formulated as a one-pack composition containing the blended latex, or as a two-pack system where the latex and the poly(alkylenimine) are blended prior to use.

An acetoacetoxy-functional polymer of the invention can be the emulsion polymerization product of:

(i) about 0.5 to about 30 wt % of an acetoacetoxy-functional monomer, with a preferred range of about 2 to about 25 wt %, or about 5 to about 20 wt %;

(ii) about 0.3 to about 6 wt % of a carboxylic acid-functional vinyl monomer, with a preferred range of about 0.5 to about 4 wt %; and

(iii) about 60 to about 99.2 wt % of a non-acid, non-acetoacetoxy vinyl monomer, with a preferred range of about 70 to about 99.2 wt %.

An acetoacetoxy-functional polymer of the invention may also contain (iv) about 0.5 to about 5 wt % of a non-self polymerizing, surface-active vinyl monomer, preferably about 1.0 to about 3.0 wt %, and (v) about 0.1 to about 10 wt % of an adhesion-promoting monomer. The wt % is based on the total amount of monomer.

An acetoacetoxy moiety is capable of forming a chelating interaction with a metal surface such as steel, an example of which is illustrated below. This interaction promotes adhesion to a metal surface and provides anti-corrosive properties to a latex or coating composition containing an acetoacetoxy-functional polymer according to the invention.

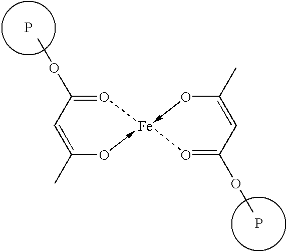

The number of polar groups, such as an acetoacetoxy group, may affect the degree of adhesion to the metal surface. If there are large numbers of polar groups present (e.g., acetoacetoxy moieties), the resulting adsorbed polymer layer at equilibrium may be of a less than desirable thickness. This principle can be illustrated by considering a polymer molecule with an aliphatic backbone chain and polar groups substituted on every other carbon atom along the chain. At equilibrium, adsorption of the adjacent polar groups is favored sterically, resulting in a thin adsorbed layer with the polar groups situated on the metal's surface. Accordingly, control of the concentration of the acetoacetoxy-functional monomer directly impacts upon the observed adhesive properties of the latexes of the invention.

A latex composition of the invention may be prepared by free radical emulsion polymerization of a non-acid vinyl monomer having an acetoacetoxy functionality such as those represented by Formula (1) below, with carboxylic acid-functional vinyl monomers, and with non-acid, non-acetoacetoxy vinyl monomers. The polymerization reaction affords a water-based dispersion of polymer particles with the polymer having pendant acetoacetoxy groups. A pendant acetoacetoxy group is not limited to those at the termini of the polymer. Pendant acetoacetoxy groups also include groups attached to the polymer's backbone and available for further reaction.

Any vinyl monomer having an acetoacetoxy-type functionality may be used to prepare an acetoacetoxy-functional polymer of the invention. Of such monomers, preferred monomers are those represented by Formula (I):

R¹—CH═C(R²)C(O)—X¹—X²—X³—C(O)—CH₂—C(O)—R³ (I)

For an acetoacetoxy-type monomer of Formula (I), R¹ is a hydrogen or halogen; R² is a hydrogen, halogen, C₁-C₆ alkylthio group or C₁-C₆ alkyl group; R³ is a C₁-C₆ alkyl group; X¹ and X³ are independently O, S or a group of the formula —N(R′)—, where R′ is hydrogen or a C₁-C₆ alkyl group; and X² is a C₂-C₁₂ alkylene group or a C₃-C₁₂ cycloalkylene group. The alkyl and alkylene groups described here and throughout the specification may be straight or branched groups. Preferred monomers of Formula (I) include acetoacetoxyethyl methacrylate, acetoacetoxyethyl acrylate, acetoacetoxy (methyl)ethyl acrylate, acetoacetoxypropyl acrylate, allyl acetoacetate, acetoacetamidoethyl (meth)acrylate, and acetoacetoxybutyl acrylate. Acetoacetoxyethyl methacrylate (AAEM) represents a particularly preferred monomer. The term “(meth)acrylate” is used here, and throughout the specification, to denote both methacrylate and acrylate monomers.

Adhesion is enhanced by the use of latex polymers having multiple hydrogen donating and accepting groups. Carboxylic acid-functional vinyl monomers, for example, function as strong hydrogen-donating groups, which in turn promote adhesion of the coating composition to the metal's surface. Hence, incorporating an appropriate amount of a carboxylic acid-functional vinyl monomer into an acetoacetoxy-functional polymer, according to the invention, improves a latex's or a coating composition's anti-corrosive properties. Too much of a carboxylic acid-functional vinyl monomer increases hydrophilicity, and too little decreases anti-corrosive properties. The carboxylic acid-functional vinyl monomer may also aid in the enamine formation step, by acting as a catalyst to facilitate transformation of the acetoacetoxy functionality to an enamine functionality in those compositions containing a blend of an acetoacetoxy functional polymer and a poly(alkylenimine), discussed below.

The acid-functional vinyl monomer of the invention may be selected broadly from carboxylic acids, phosphonic acids, acid anhydrides, phosphate monomers, and other functionalities which are capable of reacting with a base to form a salt. Examples of suitable carboxylic acid-functional vinyl monomers, or vinyl monomers capable of providing carboxylic acid-functionality, include, but are not limited to, acrylic acid, methacrylic acid, itaconic acid, itaconic anhydride, citraconic acid, citraconic anhydride, and maleic anhydride. Acrylic acid, methacrylic acid, itaconic acid and maleic anhydride represent preferred carboxylic acid-functional monomers, or monomers capable of providing carboxylic acid-functionality. Examples of suitable phosphate monomers include vinyl phosphoric acid, such as Rhodia's DV-6280® product, Sartomer's CD-9050® product, and Hardwick's T-MULZ HP® product.

The acetoacetoxy-functional polymer in the latex of the invention also contains non-acid, non-acetoacetoxy vinyl monomers. One type of non-acid, non-acetoacetoxy vinyl monomer which may be used is represented by the general Formula (II):

CH₂═C(R¹)C(O)O—R² (II)

wherein R¹ is hydrogen or a C₁-C₃ alkyl group, and R² is a C₁-C₂₀ alkyl, phenyl, benzyl, hydroxy-(C₁-C₄)-alkyl, (C₁-C₄)-alkoxy-(C₁-C₄)-alkyl, cyclopentyl, cyclohexyl, furyl, (C₁-C₄)-alkyl-furyl, tetrahydrofuryl, or (C₁-C₄)-alkyl-tetrahydrofuryl group, or a combination of two or more of these monomers. Variations of R¹ can be used to modify the glass transition temperature (T_{g}) of the film of the copolymer.

Specific examples of suitable non-acid, non-acetoacetoxy vinyl monomers include, but are not limited to, methyl (meth)acrylate, ethyl (meth)acrylate, butyl (meth)acrylate, hexyl (methacrylate), isooctyl (methacrylate), isodecyl (meth)acrylate, lauryl (meth)acrylate, stearyl (meth)acrylate, phenoxyethyl (meth)acrylate, methoxyethyl (meth)acrylate, benzyl (meth)acrylate, furyl (meth)acrylate, methylfuryl (meth)acrylate, butylfuryl (meth)acrylate, tetrahydrofuryl (meth)acrylate, ethoxyethyl (meth)acrylate, 2-ethylhexyl (meth)acrylate, cyclopentyl (meth)acrylate, isobornyl (meth)acrylate, hydroxyethyl (meth)acrylate, hydroxypropyl (meth)acrylate, and combinations or mixtures thereof. Other non-acid, non-acetoacetoxy vinyl monomers that may be used include styrene derivatives and vinyl derivatives. Examples of suitable styrene derivatives include, but are not limited to, styrene, vinyl toluene, o-methyl styrene, p-methyl styrene and m-methyl styrene. Vinyl derivatives include, but are not limited to, vinyl esters such as vinyl acetate, vinyl propionate, vinyl 2-ethylhexanoate, vinyl neononoate, vinyl neodecanoate, and vinyl esters of versatic acid. Such monomers are described in The Brandon Worldwide Monomer Reference Guide and Sourcebook, Second Edition, 1992, Brandon Associates, Merrimack, N.H.; and in Polymers and Monomers, the 1996-1997 Catalog from Polyscience, Inc., Warrington, Pa.

In addition to the monomers discussed above, the acetoacetoxy-functional polymer may also contain about 0.5 to about 5.0 wt % of at least one non-self-polymerizable, surface-active vinyl monomer. Such monomers are also known as non-self-polymerizable ethylenically-unsaturated surfactants, or reactive surfactants. A non-self-polymerizable surfactant monomer, rather than polymerizing with itself to form a separate polymeric surfactant, is substantially (preferably completely) incorporated into the polymer of the invention. Thus, the surfactant becomes part of the polymer. Non-self-polymerizing surfactants possessing, for example, propenylphenyl or allyl groups are preferred. Examples include surface active monomers sold by PPG Industries, Inc., as MAZON® SAM 181, 183, 184 and 211 surfactants, which are anionic sulfates, or sulfonates and MAZON®SAM 185-187 surfactants, which are nonionic surfactants.

Other non-self-polymerizing, surface-active vinyl monomers include the macro-monomers sold by Daiichi Kogyo Seiyaku under the names NIOGEN RN, AQUARON, and HITENOL. These surfactants include polyoxyethylene alkyl phenyl ether compounds of the general formulae (3), (4) and (5):

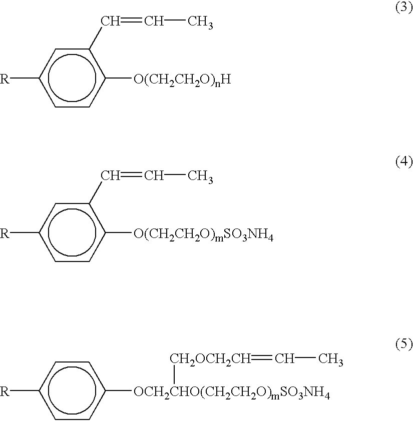

In Formulae (3), (4) and (5), R is nonyl or octyl, and n and m are preferably integers of from 15 to 50 and 15 to 40, respectively. More preferably, n ranges from 20 to 40, and m from 15 to 215. HITENOL RN, HITENOL HS-20, HITENOL A-10, and HITENOL BC-20 are particularly preferred non-self-polymerizing surface-active monomers.

In another embodiment of the invention, the acetoacetoxy-functional polymer may also comprise about 0.1 to 10 wt % of an adhesion-promoting monomer. One example of an adhesion-promoting monomer is an amide-containing vinyl monomer, in which the amide group promotes wet adhesion. Examples of such amide-containing monomers include, but are not limited to, vinyl pyrrolidone, acrylamide, and N-substituted acrylamides. Preferred N-substituted acrylamides include N-methylol acrylamide, N, N-dimethyl acrylamide, N-ethyl (meth)acrylamide, N-t-butyl (meth)acrylamide, N-t-octyl (meth)acrylamide, N-decyl (meth)acrylamide, N-dodecyl (meth)acrylamide, ethylpentyl (meth)acrylamide, and butylphenyl (meth)acrylamide. Another type of adhesion-promoting monomer is an amine-containing vinyl monomer. Amine groups are strongly hydrogen accepting, and are not easily displaced by water on the metal surface. Suitable examples of amine-containing monomers include, but are not limited to, t-butylaminoethyl (meth)acrylate, di-(alkyl)aminoethyl (meth)acrylates, N, N-di-(alkyl)aminopropyl (meth)acrylates, 2-t-butylaminoethyl (meth)acrylate, N, N-di-(alkyl)aminoethyl (meth)acrylates, and ureido monomers such as N-(2-methacryloxy-ethyl)ethylene urea.

A latex composition of the invention containing an acetoacetoxy-functional latex may be prepared using emulsion polymerization techniques such as those known in the art. Chain transfer agents, initiators, reducing agents, buffers, and catalysts, known in the art of emulsion polymerization, may be used to prepare the polymers.

Exemplary chain transfer agents include, but are not limited to, butyl mercaptan, t-butyl mercaptan, dodecyl mercaptan, mercaptopropionic acid, 2-ethylhexyl 3-mercaptopropionate, n-butyl 3-mercaptopropionate, octyl mercaptan, isodecyl mercaptan, octadecyl mercaptan, mercaptoacetic acid, allyl mercaptopropionate, allyl mercaptoacetate, crotyl mercaptopropionate, crotyl mercaptoacetate, and haloalkyl compounds such as carbon tetrabromide and bromodichloromethane. In particular, 2-ethylhexyl 3-mercaptopropionate represents a preferred chain transfer agent.

Typical initiators include hydrogen peroxide, potassium or ammonium persulfate, dibenzoyl peroxide, lauryl peroxide, ditertiary butyl peroxide, 2,2′-azobisisobutyronitrile, t-butyl hydroperoxide, and cumene hydroperoxide. A preferred amount of a peroxide or persulfate initiator is about 0.1 to about 2.0 wt %.

Redox initiators may also be used, and include, but are not limited to, combinations of peroxygen or persulfate compounds with sodium metabisulfite, sodium formaldehyde sulfoxylate, ascorbic acid, isoascorbic acid, glyoxal bisulfite, or divalent iron salt. The preferred amount of a redox initiator system is about 0.05 to about 1.5 wt %.

Polymerization catalysts are those compounds which increase the rate of polymerization and which, in combination with the above described reducing agents, may promote decomposition of the polymerization initiator under the reaction conditions. Suitable catalysts include transition metal compounds such as, for example, ferrous sulfate heptahydrate, ferrous chloride, cupric sulfate, cupric chloride, cobalt acetate, cobaltous sulfate, and mixtures thereof.

After polymerization, the pH of the gel-free emulsion is partially neutralized with a low molecular weight organic base. The base may be added to an aqueous dispersion of either the acetoacetoxy-functional polymer latex prior to the addition of a poly(alkylenimine), or to the blend of the acetoacetoxy-functional latex and a poly(alkylenimine). Latexes having pH values in the range of about 7.0 to about 10.5 may be achieved using such bases. Low molecular weight organic bases include, for example, ammonia, monoethanolamine, diethanolamine, triethanolamine, 2-methyl-2-amino-1-propanol (AMP), 2-amino-2-methyl propanediol, N, N-dimethyl-2-amino-2-methyl-1-propanol, monoisopropanolamine, triisopropanolamine, morpholine, monoamine glycols, ethylenediamine, diethylenetriamine, and the like. Mixtures of low molecular weight bases may also be used. The preferred amount of low molecular weight organic base is in the range of 50 to 80 mole percent, where the mole percent is based on the total number of moles of the acetoacetoxy-functional monomers and the carboxylic acid functional vinyl monomers present in the acetoacetoxy-functional polymer.

In addition to the above discussed non-self-polymerizing, surface-active monomers that may be used in preparing the latexes of the invention, other anionic and/or nonionic surfactants may also be used in the latexes of the invention. Examples of suitable anionic surfactants include, but are not limited to, sodium lauryl sulfate, sodium octylphenol glycolether sulfate, sodium dodecylbenzene sulfonate, sodium lauryl-diglycol sulfate, and ammonium tri-t-butyl phenol. Suitable nonionic surfactants include, but are not limited to, alkyl polyglycol ethers such as ethoxylation products of octyl- or nonyl-phenol, diisopropyl phenol, and triisopropyl phenol.

Another embodiment of the invention is an anti-corrosive and solvent-resistant composition comprising a blend of the above-described acetoacetoxy-functional polymer latex with a poly(alkylenimine). As discussed above, addition of the poly(alkylenimine) imparts increased solvent resistance to a coating composition containing a latex/poly(alkylenimine) blend according to the invention. Other beneficial properties such as water resistance, and improved mechanical properties such as hardness and blocking resistance, also result from use of the latex/poly(alkylenimine) blend.

In general, a poly(alkylenimine) contains primary, secondary, and tertiary amine groups. Poly(alkylenimines) used in the invention may have a weight average molecular weight of about 400 to about 750,000. The poly(alkylenimine) is preferably a poly(ethylenimine) (PEI), and more preferably a low molecular weight PEI having a weight average molecular weight of less than 30,000. Such PEI compounds are commercially available from many sources and include POLYMIN poly(ethylenimine) and LUPASOL poly(ethylenimine) available from BASF Corporation. BASF poly(ethylenimine) product literature reports the ratio of primary:secondary:tertiary amine groups to be about 1:2:1. A preferred PEI, LUPASOL G35 poly(ethylenimine), has a molecular weight of about 2,000 and a ratio of primary:secondary:tertiary amine groups of about 1.5:1.4:1.

The latex/poly(alkylenimine) blends are prepared by simple mixing of the acetoacetoxy-functional polymer latex and the poly(alkylenimine). The poly(alkylenimine) may be blended with the latex in an amount up to about 30 wt % based on the amount of acetoacetoxy-functional polymer in the latex. The concentration of a poly(alkylenimine) used in the mixing reaction is less than about 8.0 wt %, based on the total weight of the monomers, and is preferably less than about 6.0 wt %.

When coated on a substrate, the primary and secondary amine groups of the poly(alkylenimine) react with the pendant acetoacetoxy groups on the acetoacetoxy-functional polymer to form enamine linkages. Enamine formation results in cross-linking of the polymer latex and typically occurs upon film formation, although there may be some enamine formation in the latex blend prior to coating. Enamine formation in the latex results in a polymeric (polyamino) enamine latex, wherein the polymeric (polyamino) enamine latex is the reaction product of an acetoacetoxy-functional polymer and a poly(alkylenimine). When the poly(alkylenimine) is a polymer such as poly(ethylenimine), the amount of poly(alkylenimine) added may depend on the molecular weight. Larger amounts of lower molecular weight poly(alkylenimines) are typically added to achieve a desired amount of crosslinking and film properties upon film formation. For higher molecular weight poly(alkylenimines), a smaller amount may be used for the desired crosslinking and film properties.

The invention relates also to water-based, anti-corrosive coating compositions containing the acetoacetoxy-functional polymer latex composition of the invention. The invention also relates to water-based, anti-corrosive and solvent-resistant coating compositions containing an acetoacetoxy-functional latex composition of the invention in combination with a poly(alkylenimine). As discussed above, the latter coating composition may be a one-pack or a two-pack system.

A coating composition according to the invention may comprise a mixture of water-based latexes of the invention, water, a solvent, a pigment (organic or inorganic), a dispersant, a defoamer, a wetting agent, and/or other additives and fillers known in the art. When a solvent is used, water-immiscible solvents are preferred.

For example, a coating composition of the invention may comprise a water-based latex of the invention, a pigment, and one or more additives or fillers used in latex paints. Such additives or fillers include, but are not limited to, leveling, rheology and flow control agents such as silicones, fluorocarbons, urethanes or cellulosics; extenders; coalescing aids; reactive coalescing aids such as those described in U.S. Pat. No. 5,349,026; flatting agents; pigment wetting and dispersing agents and surfactants; ultraviolet (UV) absorbers; UV light stabilizers; tinting pigments; extenders; defoaming and antifoaming agents; anti-settling, anti-sag and bodying agents; anti-skinning agents; anti-flooding and anti-floating agents; fungicides and mildewcides; thickening agents; plasticizers; reactive plasticizers; and curing agents. Specific examples of such additives can be found in Raw Materials Index, published by the National Paint & Coatings Association, 1500 Rhode Island Avenue, NW, Washington, D.C. 20005.

A water-based latex of the invention can be utilized alone or in conjunction with other conventional waterborne polymers. Such polymers include, but are not limited to, water dispersible polymers such as polyesters, polyester-amides, cellulose esters, alkyds, polyurethanes, epoxy resins, polyamides, acrylics, vinyl polymers, styrene-butadiene polymers, vinylacetate-ethylene copolymers, and the like.

Upon formulation, a coating composition containing a water-based latex of the invention may be applied to metal surfaces using means known in the art. For example, a coating composition may be applied by spraying or by coating a metal substrate. In general, the coating may be dried by heating but preferably is allowed to air dry. Advantageously, a coating employing a water-based latex of the invention may be thermally or ambiently cured.

A water-based coating composition according to the invention may be used on any metal substrate subject to corrosion. The coating compositions are particularly suited for maintenance paint applications, such as used with iron or steel industrial and transportation structures.

### EXAMPLES

The following examples below are intended to illustrate, not limit, the invention.

The examples use the following materials:

HITENOL BC-20, a non-self-polymerizing surfactant, sold by Daiichi Kogyo Seiyaku.

PROXEL GXL, a preservative, sold by Zeneca.

LUPASOL G35, a poly(ethylenimine), sold by BASF.

SURFYNOL® DF-210, a defoamer, sold by Air Products and Chemicals, Inc.

SURFYNOL® CT-131, a dispersant, sold by Air Products and Chemicals, Inc.

SURFYNOL® 104 DPM, a wetting agent, sold by Air Products and Chemicals, Inc.

MAPHOS 60A, a phosphate ester, sold by BASF.

ABEX 2545, a surfactant, sold by Rhodia.

AMPS (2-acrylamido-2-methylpropane-1-sulfonic acid), a surfactant, sold by Lubrizol Corporation.

AEROSOL NPES-2030, a surfactant, sold by Cytec.

TI-PURE® R-706, a titanium dioxide pigment, sold by E. I. DuPont de Nemours.

TEXANOL® ester alcohol, a coalescing aid, sold by Eastman Chemical Company.

BYK-025, sold by BYK Chemie.

ACRYSOL® RM-8W, sold by Rohm & Haas.

DPnB (di-(propylene glycol)-n-butyl ether), sold by Dow Chemical.

### Example 1

### Preparation of Surfactant-Stabilized Acetoacetoxy-Functional Polymer 1

An emulsion polymerization was conducted in a two-liter reaction kettle equipped with a condenser, a stirring shaft with a motor, and a nitrogen purge. To the reaction kettle, 203 g of deionized (DI) water and 7.0 g of an 18 wt % solution of HITENOL BC-20 were added. The contents of the reactor were then heated to 85° C. In a separate flask, a mixture of 301 g of styrene, 83.3 g of methyl methacrylate, 310 g of butylacrylate, 0.4 g of hydroxyethyl methacrylate, 126 g of 2-acetoacetoxyethyl methacrylate, 17.0 g of methacrylic acid, and 2.4 g of isooctylmercaptopropionate were stirred into 500 g of water containing 1.7 g of ammonium carbonate and 75.5 g of a 18 wt % solution of HITENOL BC-20. Approximately 57.3 g of the monomer mixture was then added to the reactor followed by 1.3 g of ammonium persulfate dissolved in 18 g of water. The remaining monomer emulsion was then fed into the reactor over a 250 minute period. During the same period, 2.6 g of ammonium persulfate and 1.7 g of ammonium carbonate dissolved in 55 g of water were fed into the reactor. After all of the monomer feed was in the reactor, the contents were cooled to 65° C., and 3.6 g of t-butylhydroperoxide in 18 g of water and 2.6 g of sodium formaldehyde sulfoxylate in 18 g of water were fed into the reactor over 20 minutes. This was followed by 36.4 g of a 28% aqueous solution of ammonium hydroxide and 1.7 g of PROXEL GXL. The latex was filtered through 100 mesh screen.

### Example 2

### Preparation of a Blend of Surfactant-Stabilized Acetoacetoxy-Functional Polymer 1 with a Poly(alkylenimine) I

Into the above described kettle containing 2400 g of the surfactant-stabilized acetoacetoxy-functional latex polymer generated in Example 1 was mixed 7.8 g of a 28% ammonia solution, 0.8 g of SURFYNOL® DF-210, and 233 g of a 10% solution of the polyethylenimine LUPASOL G35. Solid content was 45.5%.

### Example 3

### Preparation of a Blend of Surfactant-Stabilized Acetoacetoxy-Functional Polymer 1 with DETA

Into the above described kettle containing 2400 g of the surfactant-stabilized acetoacetoxy-functional latex polymer generated in Example 1 was mixed 52 g of diethylenetriamine (DETA).

### Example 4

### Preparation of a Surfactant-Stabilized Acetoacetoxy-Functional Polymer 2—Comparative Example

An emulsion polymerization was conducted in a two-liter reaction kettle equipped with a condenser, a stirring shaft with motor, and a nitrogen purge. Approximately 557 g of DI water, 7.20 g of MAPHOS 60A, and 2.57 g of ammonium hydroxide (28% NH₃ content) were added to the kettle. The contents of the reactor were then heated to 80° C. In a separate flask, a mixture of 379 g of styrene, 255 g of butylacrylate, 72 g of 2-acetoacetoxyethyl methacrylate, and 28.8 g of 2-acrylamido-2-methylpropane-1-sulfonic acid (AMPS) surfactant were stirred into 340 g of water containing 2.57 g of ammonium hydroxide (28% NH₃ content) and 4.32 g MAPHOS 60A. Approximately 30.3 g of the monomer mixture was then added to the reactor followed by 1.44 g of ammonium persulfate dissolved in 9.0 g of water. After a 15 minute hold period, the remaining monomer emulsion was then fed into the reactor over a 180 minute period. During the same period, 1.44 g of ammonium persulfate dissolved in 21.5 g of water was also fed into the reactor. After all of the monomer feed was added to the reactor, the contents were cooled to 65° C. and 0.82 g of t-butylhydroperoxide in 11 g of water and 0.58 g of sodium metabisulfite in 11 g of water were fed into the reactor over 20 minutes. This addition was followed by 72.0 g of ABEX 2545 surfactant.

### Example 5

### Preparation of a Blend of Surfactant-Stabilized Acetoacetoxy-Functional Polymer 2 with a Poly(alkylenimine) I—Comparative Example

Into the above described kettle containing 2400 g of the surfactant-stabilized acetoacetoxy-functional latex polymer generated in Example 4 was mixed 2.73 g of a 95% aminoethyl propanol solution followed by 144 g of LUPASOL G35. The latex was then filtered through 100 mesh screen and the particle size was measured by DLS to be 123 nm.

### Example 6

### Preparation of an Acetoacetoxy-Functional Polymer with a Non-Polymerizable Surfactant

An emulsion polymerization was conducted in a two-liter reaction kettle equipped with a condenser, a stirring shaft with motor, and a nitrogen purge. Approximately 205 g of DI water and 4.25 g of AEROSOL NPES-2030 (a 30% active surfactant from Cytec) were added. The contents of the reactor were then heated to 85° C. In a separate flask, a mixture of 306 g of styrene, 84.6 g of methylmethacrylate, 314 g of butylacrylate, 0.42 g of hydroxyethyl methacrylate, 126 g of 2-acetoacetoxyethyl methacrylate, 17.0 g of methacrylic acid, and 3.40 g of iso-octylmercaptopropionate were stirred into 500 g of water containing 1.70 g of ammonium carbonate and 45.3 g of AEROSOL NPES-2030. Approximately 57.2 g of the monomer mixture was then added to the reactor followed by 1.27 g of ammonium persulfate dissolved in 18 g of water. The remaining monomer emulsion was then fed into the reactor over a 250 minute period. During the same period, 2.55 g of ammonium persulfate and 1.70 g of ammonium carbonate dissolved in 55.1 g of water was fed into the reactor. After all of the monomer feed was in the reactor, the contents were cooled to 65° C., and 3.64 g of t-butylhydroperoxide in 18.4 g of water and 2.55 g of sodium formaldehyde sulfoxylate in 18.4 g of water were fed into the reactor over 20 minutes. This addition was followed by 36.4 g of a 28% ammonium hydroxide solution and 1.70 g of PROXEL GXL. The latex was filtered through 100 mesh screen and the particle size was measured by DLS to be 138 nm.

### Example 7

### Preparation of a Blend of Acetoacetoxy-Functional Polymer 6 with a Poly(alkylenimine) I

Into the above described kettle containing 970 g of the acetoacetoxy-functional latex polymer (containing no polymerizable surfactant) generated in Example 6 was mixed 6.0 g of a 28% ammonia solution, followed by 0.4 g of SURFYNOL® DF-210 and 44.0 g of a 20% solution of LUPASOL G35.

Formulation of the Coatings

The anti-corrosive performance and application properties of a coating are affected by the choice of paint ingredients. The preferred amount of each ingredient in a sample composition is listed in Table 1.

TABLE 1
Gloss Topcoat for Airless Spray Application

| INGREDIENTS | POUNDS |
|---|---|
| Grind Preparation | |
| Water | 58.81 |
| 28 % Ammonia | 0.80 |
| SURFYNOL CT-131 | 6.07 |
| SURFYNOL 104 DPM | 1.49 |
| SURFYNOL DF-210 | 0.49 |
| BYK-025 | 1.18 |
| Ti-Pure 706 | 197.34 |
| 20% RM-8W/water | 0.19 |
| Grind to 7 Hegman | |
| Letdown Preparation | |
| Water | 20.84 |
| Latex (Examples 1, 2, 3 and 5) | 654.62 |
| BYK-025 | 3.30 |
| 15% Sodium Nitrite | 7.53 |
| Texanol/DPnB* | 11.84/32.41 |
| 20% RM-8W/water | 3.09 |
| | 1000.00 |

*DPn3 = di-(propylene glycol)-n-butyl ether

Test Methods

There has been an increased recognition of the importance of wet/dry cycling, or cyclic stress factors in general, and the influence of weathering factors (e.g., UV light exposure and moisture condensation) in the overall paint degradation and corrosion process. This recognition is due to the fact that corrosion at the paint/metal interface and weathering of paint films are processes occurring simultaneously and may be significantly interrelated. For example, weather-induced degradation of a paint's organic binder may result in a more hydrophilic coating surface which could alter the time-of-wetness and subsequent corrosion characteristics of the system. Accordingly, several varied tests were conducted to evaluate the overall effectiveness of the anti-corrosive capabilities of the invention.

1. Salt Fog Spray

Standards from the American Society for Testing and Materials (ASTM) were employed for this test. The coatings were drawn down onto cold roll steel (R-36) panels and cured in a constant temperature and humidity room for 7 days. The dry film thickness was measured at 3.0+/−0.3 mils. The panels were then exposed to salt fog spray (ASTM B117) to assess their utility in anti-corrosive coatings formulations. In this test, the components to be tested are prepared and suspended in a sealed chamber where they are subjected to a spray or fog of a neutral 5% salt solution which is atomized at a temperature of 95° F. Testing of this type is considered useful when evaluating the behavior of materials subjected to a marine environment. Overall rusting (ASTM D610) and blistering (ASTM D714) were evaluated, as well as rusting and blistering at the scribe (ASTM D1654) after designated time periods.

2. Cleveland Humidity Resistance

Cleveland humidity resistance was also conducted as a primary test and measured humidity resistance under high humidity and high temperature conditions. In the test, steel panels were exposed to 100% relative humidity at 50° C. The panels were then evaluated for rusting and blistering according to ASTM D610 and ASTM D714, respectively. Gloss and gloss retention were also examined.

3. QUV Weathering Test (QUV)

The QUV weathering test assesses anti-corrosion, and reproduces the damage caused by sunlight, rain and dew. The QUV tests materials by exposing them to alternating cycles of light and moisture at controlled, elevated temperatures. The QUV simulates the effect of sunlight with fluorescent ultraviolet (UV-A or UV-B) lamps while the test simulates dew and rain with condensing humidity and water sprays. Exposure conditions can be varied to simulate various end-use environments. The QUV can reproduce damage that occurs over months or years outdoors in only a few weeks. Surface chalking, gloss, and gloss retention are characteristics typically used in assessing weathering. A QUV-weathering/corrosion cabinet was used to assess the effect of wet/dry cycles, UV light exposure, and moisture condensation on the coated panels which were placed inside the cabinet.

4. MEK Rubs

Polymer films dried at specified conditions were constantly soaked with methyl ethyl ketone (MEK). Data was obtained using a crockmeter with a 1 kg weight placed on the arm for a total weight of approximately 1500 g. The test, which measures resistance to MEK, ended when the breakthrough of the film on the panel was first observed. Data were reported as MEK double rubs (one set of back and forth).

Other tests such as hardness, appearance, gloss and gloss retention were also used to assist in the evaluation.

Results

The results of panels coated with paints formulated with the latexes described in Examples 1, 2, 3, 5, 6 and 7 and exposed to 300 hours of exposure to salt fog spray are depicted in FIG. (1). Examples 1, 2 and 6 demonstrated excellent corrosion resistance, with the Example 2 panel (coated with a surfactant-stabilized acetoacetoxy functional latex formulation) and the Example 6 panel (coated with an acetoacetoxy functional latex formulation lacking any polymerizing surfactant) showing particular resistance to the harsh test conditions employed. Example 3 (using DETA rather than a PEI) showed substantial corrosion and Example 5 (no carboxylic acid-functional vinyl monomer) revealed little or no anti-corrosive properties.

Results of the Cleveland humidity test, depicted in FIG. (2), indicated that the panels coated with formulations of Examples 1, 2, 6 and 7 were resistant to rust and blister and retained a good gloss. Panels coated with formulations of Example 5, and especially Example 3, showed fading and substantial blistering under similar conditions.

The results of the QUV tests for Examples 1, 2, 3 and 5 depicted in FIGS. (3) and (4) demonstrate the effect of weathering on gloss at 60° and 20° readings, respectively. The panels coated with formulations of Examples 1 and 2 exhibited good gloss retention in contrast to Examples 3 and 5 where the films quickly lost integrity, and gloss, and became chalky in the QUV-weathering cabinet.

Table 2 demonstrates that MEK double rubs of the paint formulated with Example 7 are above 600, while the results of Examples 2 and 3 exhibit values above 100. This finding is particularly significant since MEK double rubs of most waterborne 1-K coatings are less than 100.

TABLE 2
MEK Double Rubs

| | MEK(1)* | MEK(2)* |
|---|---|---|
| Example 1 | 30 | 75 |
| Example 2 | 253 | 415 |
| Example 3 | 126 | 151 |
| Example 5 | 58 | 90 |
| Example 6 | 37 | — |
| Example 7 | 680 | — |

*(1) Panels were cured in a controlled temperature (25° C.) and humidity (50%) room for seven days.
*(2) Panels were cured in a controlled temperature (25° C.) and humidity (50%) room for seven days, followed by forced cure at 60° C. for one day.

It should be understood that the foregoing discussion and examples merely present a detailed description of certain preferred embodiments. It will be apparent to those of ordinary skill in the art that various modifications and equivalents can be made without departing from the spirit and scope of the invention. All the patents, journal articles and other documents discussed or cited above are herein incorporated by reference.

We claim:

1. A latex composition comprising an acetoacetoxy-functional polymer which comprises the emulsion polymerization product of:
(i) about 0.5 to about 30 wt % of at least one acetoacetoxy-functional monomer;
(ii) about 0.3 to about 6 wt % of at least one carboxylic acid-functional vinyl monomer; and
(iii) about 60 to about 99.2 wt % of at least one non-acid, non-acetoacetoxy vinyl monomer.

2. The latex composition of claim 1, wherein the at least one acetoacetoxy-functional monomer includes at least one monomer of Formula (1):
R¹—CH═C(R²)C(O)—X¹—X²—X³—C(O)—CH₂—C(O)—R³ (I)
wherein R¹ is a hydrogen or halogen; R² is a hydrogen, halogen, C₁-C₆ alkylthio group or C₁-C₆ alkyl group; R³ is a C₁-C₆ alkyl group; X¹ and X³ are independently O, S or a group of the formula —N(R′)—, in which R′ is hydrogen or a C₁-C₆ alkyl group; and X² is a C₁-C₁₂ alkylene group or C₃-C₁₂ cycloalkylene group.

3. The latex composition of claim 1, wherein the monomers polymerized to produce the acetoacetoxy-functional polymer further comprise (iv) about 0.5 to about 5 wt % of at least one non-self polymerizing, surface-active vinyl monomer.

4. The latex composition of claim 1, wherein the monomers polymerized to produce the acetoacetoxy-functional polymer further comprise about 0.1 to about 10 wt % of at least one adhesion-promoting monomer selected from the group consisting of an amine-containing vinyl monomer, an amide-containing vinyl monomer, and mixtures thereof.

5. The latex composition of claim 1, wherein the at least one carboxylic acid-functional vinyl monomer includes methacrylic acid.

6. The latex composition of claim 2, wherein the at least one monomer of Formula (I) includess at least one member selected from the group consisting of acetoacetoxyethyl methacrylate, acetoacetoxyethyl acrylate, acetoacetoxy(methyl)ethyl acrylate, acetoacetoxypropyl acrylate, allyl acetoacetate, acetoacetamidoethyl (meth)acrylate, and acetoacetoxybutyl acrylate.

7. The latex composition of claim 3, wherein the monomers polymerized to produce the acetoacetoxy-functional polymer further comprise about 0.1 to about 10 wt % of at least one adhesion-promoting monomer selected from the group consisting of an amine-containing vinyl monomer, an amide-containing vinyl monomer, and mixtures thereof.

8. The latex composition of claim 3, wherein the at least one acetoacetoxy-functional monomer includes at least one member selected from the group consisting of acetoacetoxyethyl methacrylate, acetoacetoxyethyl acrylate, acetoacetoxy(methyl)ethyl acrylate, acetoacetoxypropyl acrylate, allyl acetoacetate, acetoacetamidoethyl (meth)acrylate, and acetoacetoxybutyl acrylate; and wherein the non-self-polymerizing, surface-active vinyl monomer includes at least one polyoxyethylene alkyl phenyl ether of formulae (3), (4) or (5): 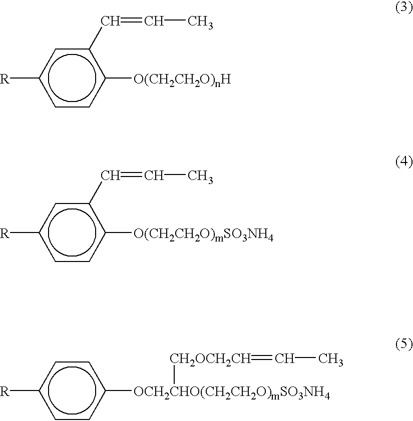
wherein R is nonyl or octyl, n ranges from 15 to 50, and m ranges from 15 to 40.

9. The latex composition of claim 3, wherein the latex composition is comprised of particles having a size that ranges from about 80 nm to about 300 nm.

10. The latex composition of claim 1, wherein the pH of the composition ranges from about 7.0 to about 10.5.

11. The latex composition of claim 3, wherein the pH of the composition ranges from about 7.0 to about 10.5.

12. The latex composition of claim 1, further comprising a low molecular weight organic base.

13. The latex composition of claim 3, further comprising a low molecular weight organic base.

14. The latex composition of claim 12, wherein the low molecular weight organic base is selected from ammonia, 2-amino-2-methyl-1-propanol, and mixtures thereof.

15. The latex composition of claim 13, wherein the low molecular weight organic base is selected from ammonia, 2-amino-2-methyl-1-propanol, and mixtures thereof.

16. A latex composition comprising:
an acetoacetoxy functional polymer which comprises the emulsion polymerization product of:
(i) about 0.5 to about 30 wt % of at least one acetoacetoxy-functional monomer;
(ii) about 0.3 to about 6 wt % of at least one carboxylic acid-functional vinyl monomer; and
(iii) about 60 to about 99.2 wt % of at least one non-acid, non-acetoacetoxy vinyl monomer; and
at least one poly(alkylenimine).

17. The latex composition of claim 16, wherein the at least one acetoacetoxy-functional monomer includes at least one monomer of Formula (1):
R¹—CH═C(R²)C(O)—X¹—X²—X³—C(O)—CH₂—C(O)—R³ (I)
wherein R¹ is a hydrogen or halogen; R² is a hydrogen, halogen, C₁-C₆ alkylthio group or C₁-C₆ alkyl group; R³ is a C₁-C₆ alkyl group; X¹ and X³ are independently O, S or a group of the formula —N(R′)—, in which R′ is hydrogen or a C₁-C₆ alkyl group; and X² is a C₁-C₁₂ alkylene group or C₃-C₁₂ cycloalkylene group.

18. The latex composition of claim 16, wherein the monomers polymerized to produce the acetoacetoxy-functional polymer further comprise (iv) about 0.5 to about 5 wt % of at least one non-self polymerizing, surface-active vinyl monomer.

19. The latex composition of claim 16, wherein the monomers polymerized to produce the acetoacetoxy-functional polymer further comprise about 0.1 to about 10 wt % of at least one adhesion-promoting monomer selected from the group consisting of an amine-containing vinyl monomer, an amide-containing vinyl monomer, and mixtures thereof.

20. The latex composition of claim 16, wherein the at least one poly(alkylenimine) includes poly(ethylenimine).

21. The latex composition of claim 17, wherein the at least one monomer of Formula (I) includes a member selected from the group consisting of acetoacetoxyethyl methacrylate, acetoacetoxyethyl acrylate, acetoacetoxy(methyl)ethyl acrylate, acetoacetoxypropyl acrylate, allyl acetoacetate, acetoacetamidoethyl (meth)acrylate, and acetoacetoxybutyl acrylate.

22. The latex composition of claim 21, wherein the at least one acetoacetoxy-functional monomer includes a member selected from the group consisting of acetoacetoxyethyl methacrylate, acetoacetoxyethyl acrylate, acetoacetoxy(methyl)ethyl acrylate, acetoacetoxypropyl acrylate, allyl acetoacetate, acetoacetamidoethyl (meth)acrylate, and acetoacetoxybutyl acrylate, and wherein the at least one non-self-polymerizing, surface-active vinyl monomer includes at least one polyoxyethylene alkyl phenyl ether of formulae (3), (4) or (5): 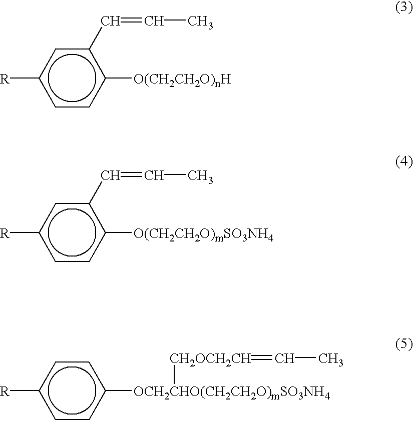
wherein R is nonyl or octyl, n ranges from 15 to 50, and m ranges from 15 to 40.

23. The latex composition of claim 21, wherein the latex composition comprises particles having a size that ranges from about 80 nm to about 300 nm.

24. The latex composition of claim 21, wherein the monomers polymerized to produce the acetoacetoxy-functional polymer further comprise about 0.1 to about 10 wt % of at least one adhesion-promoting monomer selected from the group consisting of an amine-containing vinyl monomer, an amide-containing vinyl monomer, and mixtures thereof.

25. A water-based coating composition, comprising the latex composition of claim 1, and at least one member selected from the group consisting of a pigment, a leveling agent, a rheology agent, a flow control agent, an extender, a coalescing aid, a reactive coalescing aid, a flatting agent; a pigment wetting agent, a dispersing agent, a surfactant; an ultra-violet (UV) absorber; a UV light stabilizers, a tinting pigment, extenders; a defoaming agent, a antifoaming agent; an anti-settling agent, an anti-sag and bodying agent; an anti-skinning agent; an anti-flooding agent; an anti-floating agent; a fungicide; a mildewcide; a thickening agent; a plasticizer; a reactive plasticizer and a curing agent.

26. A method of protecting a metal surface from corrosion, comprising contacting the metal surface with the coating composition of claim 25.
